(19) United States
(12) Patent Application Publication
(10) Pub. No.: US 2002/0191388 A1
(43) Pub. Date: Dec. 19, 2002

(54) Device and method for vehicular invisible road illumination and imaging

(76) Inventor: Oleg Matveev, Gainesville, FL (US)

Correspondence Address: Oleg Matveev, 1212 N.W. 90 th Drive, Gainesville, FL, 32606, US

(21) Appl. No.: 10/157,359

(22) Filed: May 28, 2002

Related U.S. Application Data
(60) Provisional application No. 60/295,699, filed on Jun. 5, 2001.

(51) Int. Cl. F21V 7/04

(52) U.S. Cl. 362/31

(57) ABSTRACT

A device and method for vehicular invisible road illumination and imaging is provided. The device includes invisible for human eye and precisely synchronized for all vehicles pulsed laser or nonlaser sources of light to illuminate the road. The design and method of the invention involves providing a low probability of being blinded by oncoming vehicles and illumination of the road by light pulses which are shorter than the time which is necessary for the light pulse to travel the illuminated distance observed by the driver.

Using a timing signal acquired from at least one satellite global positioning system, the period between the illuminating pulses is set the same for all vehicles with a high level of precision. The period between the illuminating pulses is divided into a predetermined number of time zones with a predetermined duration for each zone. Each predetermined time zone is assigned to a predetermined group of vehicles, for example, for military, government, law enforcement, ambulance, fire rescue, trucks, luxury vehicles, small, large vehicles etc. In order to further decrease the probability of being blinded by oncoming vehicles and also to reduce the necessary pulse energy of the illumination laser, the imaging system uses gated, spectrally selective imaging detectors with a luminosity-resolving power product at least 10⁴ cm² Sr.

To increase the reliability for the whole system, especially for the most demanding types of vehicles such as police, ambulance and fire rescue, an additional improvement is included. For these purposes an additional generator of triggering pulse is included which illuminates an electromagnetic pulse of a different frequency from that which is used to illuminate the road. This additional triggering pulse is generated prior to the pulse which illuminates the road with a predetermined time difference, precisely set for all vehicles.

### CROSS-REFERENCE TO RELATED APPLICATION

Reference is hereby made to confidential invention disclosure “Invisible headlights of car for road illumination” for the Office of Technology Licensing, University of Florida, Gainesville Fla. UF#10373 filed Jun. 1, 2000 and to provisional patent application “Invisible headlights of car for road illumination” Ser. No. 60/295,699 filed Jun. 5, 2001, the benefits, of the filing dates of which is clamed herein.

### BACKGROUND OF THE INVENTION

1. Field of the Invention

The present invention relates to nighttime driving and nighttime invisible for oncoming vehicles illumination of the road using pulsed laser and other non-laser sources of light.

2. Discussion of the Related Art

It is known that depending on the circumstances large percentage of all nighttime car accidents happened due to inadequate illumination of the road. One of the most common reasons of crashes is because drivers are blinded by oncoming cars. As known [see for example http://www.nhtsa.dot.gov/people/ncsa/ovrfacts.html (Data from the National Highway Traffic Safety Administration)] “much progress has been made in reducing the number of deaths and serious injuries on our nation's highways. However, much remains to be done. The economic cost alone of motor vehicle crashes in 1994 was more than $150.5 billion and in 2000 it is even much higher $230.6 billion.

In 1996, there were more than 18,000 fatal nighttime car crashes. About 3,500 pedestrian and 368 bicyclists were killed. Nighttime driving represents only 28 percent of total driving, it accounts for about 55 percent of all traffic fatalities. Of all pedestrian fatalities, about two-third occur at night. On a per mile basis, driving at night is more than three times as likely to result in a fatality as driving during daylight. While several factors affect these statistics, limited vision is one of the main reasons behind the high rate of accidents.”

Several scientific conceptions are under different stages of development at present to improve the nighttime driving safety. First one is using UV light, which is invisible for drivers and can be used with high beam headlights. This method is described in the U.S. Pat. No. 4,970,628 “Headlamp for automotive vehicles” issued on Nov. 13, 1990. The U.S. Pat. No. 5,255,163 “Headlight for motor vehicle” issued on Oct. 19, 1993 (Inventors: Rainer, Neumann; Stuttgart, D E) describes “a headlight for a motor vehicle comprises a gas discharge lamp as a light source emitting visible light and light in UV-wavelength region”

However the UV road illumination conception has several substantial drawbacks:

1. The UV light does not eliminate the necessity to have at least low beam headlights in the visible region of spectrum, which can be disturbing, interfering and dangerous for oncoming cars because of impairing visibility glare.

2. Many natural obstacles on the road do not produce good yield of fluorescence radiation in the visible region of spectrum (for example human body, trees, tires, stones, dents) and very often they can be better seen under illumination by visible but not UV light. If a driver would rely too much on the UV lamps he can miss important imaging information and this will lead to a higher probability of crashes.

3. The UV radiation might be hazardous from the environmental point of view. As known, many people are wearing sunglasses as protection against UV radiation to eliminate this hazard. In comparison with UV radiation from the sun which is normally seen as a scattered radiation (the brightest sun is normally above us in the sky) the UV radiation from cars will illuminate the eyes of pedestrians directly. The pedestrians will not see this radiation and will not close their eyes like if they were looking directly at the sun. At nighttime, the pupil of an eye is one-two order of magnitude larger than in the daytime. Because of this total exposure of people's eyes to UV can be much longer and more damaging. The brightness of the UV lamps is higher than the brightness of the sun and due to this, the total exposure of UV radiation per eye pixel can be one- two order of magnitude greater.

4. The UV lamp introduction will require additional US government multibillion dollars expenses to install better fluorescing materials on the roads.

5. The UV lamps do not eliminate the blinding effect of early morning or evening glare from the sun.

The second conception is the IR thernoimaging in 9-10 μm region of spectrum. This conception has already been commercialized recently. The IR thermal imaging cameras are already available on Cadillac DeVille 200 cars. See for example F. Hamit, “The Cadillac's Oncoming “Night vision” Option., Advanced Imaging, No 10, p.34-36, 1998, or Fred Schaff, Photonics Spectra, April, 2000, “Beyond the Visible”. In its December 1999 issue, “Popular Science Magazine” called night vision with IR thermoimaging cameras, as a “totally new way of looking at the world” and “a perfect example of how modem technology can make motoring safer. Today, the worldwide auto and truck market represents approximately 40 million vehicles annually, with the luxury market accounting for 1.6 million vehicles. Car illuminating business represents a billion dollar opportunity”.

However, the thermal imaging is far from being the ideal way to observing the nighttime road and it also has several drawbacks.

1. Since 9-10 μm is 20 times longer wavelength in comparison with visible radiation the spatial resolution of the image will be 20 times worse. In fact the real thermal IR image has actually only 320×240=76800 pixel that is two orders of magnitude less than the number of pixels, which human eyes or the best CCD cameras have. The image is looking as if a driver has vision approximately 1000/1000. Also having such a small number of pixels it is practically impossible to build in the future acceptable 3D stereoscopic vision system.

2. The road image contrast, sharpness and brightness from IR theroimaging system depends on the ambient temperature. Objects on the road with equal temperature, for example tires, trees or stone on the road, might not be distinguishable. During the rain or after it image is different compared with dry ambient conditions. If, for example, ambient temperature is close to 36° C. humans will not be seen or will be seen with poorly distinguishable contrast. Total brightness and contrast of the image also depends on ambient temperature. If it is too cold, for example −20-30° C. the brightness and the contrast of the images might be 2-3 times worse in comparison with +20+25° C.

Some other active and semiactive night viewing devices are known in the literature. In patent #4642452 (issued in 1987 to F. R. Loy from US Philips Corp.) a semiactive night viewing system is described which is utilizing target illuminating flash lamp pulsed system and image intensifier to detect the image. The illumination system wavelength of the light is outside of the visible spectrum. At the same time, an image storage device stores the image signal. After that, the image is read out and displayed.

An active night vision system capable of viewing a target over long distances described in the U.S. Pat. No. 5,383,200 (issued in 1995 to J. J. Barret J. Yee and W. R. Rapoport from AlliedSignal Inc.). An eye-safe pulsed laser working in the invisible for human eyes spectral region 1.52-1.76 or 2.03-2.34 μm is used to illuminate a target. Image is focused on the surface of an image intensifier and is displayed or stored. The repetition rates of laser pulses are from about 1 to about 30 pulses per second.

Third conception of invisible headlights was developed recently by DaimlerChrisler automotive company. It was described, for example, in electronic internet journal “Canadian Driver News”, Apr. 6, 2000; www.canadiandriver.com/news/000406-2.htm; or on the web site www.daimlerchrysler.de/news/top/2000/t00405_e.htm. Their laser infrared active night vision system is similar to military laser-illuminating systems for viewing long-range details (see, for example, “Laser-illuminated viewing provides long-range detail”, Laser Focus World, September 2000, p. 147-150). Because infrared light is invisible for human eyes it cannot blind drivers of oncoming vehicles. Image detecting system of this device is protected by spectrally selective filter blocking visible radiation from headlamps of oncoming vehicles. As mentioned in the article “preset optical filters are capable of reducing by a factor of 50 to 100, while still allowing the system's reflected laser light to pass through”. Another important feature of DaimlerChrysler's imaging system is that it is activated synchronously with laser pulses illuminating the road. The gate of video camera is only open a short period of time immediately after laser pulse was fired. The duration of this time-gate can be several microseconds and because of this only limited amount of light from oncoming vehicles can penetrate to the imager. As was claimed this system can provide 50-100 times reduction of the blinding effect.

The drawbacks of this infrared laser road illumination and imaging system are as follows:

1. They used rather broadband with large luminosity resolving power product spectrally selective imaging system. Because of this the imaging system acquire a rather big portion of unwanted light from headlights of oncoming vehicles with glare reducing factor only 50-100.

2. The period between laser pulses is not set with high level of precision. Therefore when many oncoming cars are moving and there is heavy traffic on the road the probability to be blinded is rather high and a driver will be forced frequently to switch off his laser illuminating system.

3. The road illumination system described in prior art needs rather high energy per pulse to get the image which is not so much distorted by the glare from standard headlights of oncoming vehicles.

### BRIEF SUMMARY OF THE INVENTION

The device and method for vehicular invisible road illumination and imaging is based on the conception of using invisible for human eyes pulsed laser and non-laser sources of light as headlights to illuminate the road and also using fast gated image detector synchronized with external triggering signal.

The design and method of the invention involve providing low probability to be blinded by oncoming vehicles thanks to specially performed illumination of road by light pulses shorter than time interval equal to illuminated distance in front of a vehicle divided by the speed of light.

Period between illuminating pulses is set the same for all vehicles with high level of precision acquiring timing signal from the satellites of at least one global positioning system which may be US GPS, Russian GLONASS, or in the near future, expected to be deployed, Europe GPS. To improve further the precision mentioned above combination of timing signals from different global positioning systems is acquired, for example, from the US Global Positioning System and the Russian Global Navigation Satellite System. Also the period between illuminating pulses is divided on predetermined number of time intervals with predetermined duration of each interval. These time intervals are defined further as time zones. Each predetermined time zone is assigned for predetermined group of vehicles, for example, for military, government, low enforcement, ambulance, fire rescue, tracks, luxury vehicles, small, big vehicles etc.

To decrease further the probability to be blinded by oncoming vehicles and also to decrease requirements for energy per pulse for illuminating laser the imaging system involve the use of gated spectrally selective image detector with luminosity-resolving power product at least 10⁴ cm² sr. Depending on the embodiment of the invention atomic vapor resonance ionization image detectors (RIID), resonance fluorescence imaging monochromators, magnetooptical filters, solid state and atomic or molecular vapor hole burning spectroscopy filters are disposed as image detectors with luminosity-resolving power product value.

To increase reliability for the whole system also for the most demanding type of vehicles like police ambulance, fire rescue additional improvement is included. For these purposes an additional generator is included, which fires a triggering electromagnetic pulse with electromagnetic frequency of its radiation different in comparison with the road illuminating pulse. This additional pulse is generated before road illuminating pulse with a predetermined and the same for all vehicles time difference. The radiation from the additional generator is directed in the same direction as laser pulse from illuminating pulsed laser. In order to detect independently from illuminating pulse spectrally separated triggering electromagnetic pulse from oncoming vehicles a detector of triggering pulse is included tuned to the electromagnetic frequency of triggering pulse. The detector of the triggering pulse is connected through a delay line with the gate of image detector to deactivate imaging og the road, while the light pulse from oncoming vehicle is active.

The main objects of this invention are:

1. To reduce visibility of glare from standard continuously illuminating headlights of oncoming vehicles and increase as a result the amount of information about the road seen by driver from display.

2. To decrease the probability to be blinded by the light from identical pulsed illumination system of oncoming vehicles.

3. To decrease required energy per pulse for the road illuminating source of light.

4. To use simultaneously the road illumination and imaging systems not only for glare reducing purposes but also as an antitheft system.

The main goal of this invention is to provide drivers with high quality image of the road (with the number of pixels to be about one million or more) by illuminating the road at long distance (330-500 m), i.e. to provide high quality, similar to the daytime illumination of the road. At the same time to eliminate the vision impairing glare from oncoming traffic and to substantially decrease the probability to be blinded when there is heavy oncoming traffic. Also the purpose is to decrease the blinding effect of the sun's glare during sunset or sunrise.

### BRIEF DESCRIPTION OF THE DRAWING

These and other features of the present invention and the attendant advantages will be readily apparent to those having ordinary skill in the art and the invention will be more easily understood from the following brief description of the drawings.

FIG. 1 is substantially schematic view of vehicular imaging system for invisible road illumination and imaging, where appearance of road illuminating pulses is synchronized with timing signal acquired from global positioning system.

FIG. 2 is substantially schematic representation of illuminating pulses positioned for different groups of vehicles in different time zones and also for vehicles which were stolen.

FIG. 2A is exploded substantially schematic representation of illuminating pulses positioning in time for two groups of vehicles assigned to two closest to each other time zones.

FIG. 3 is substantially schematic view of vehicular imaging system for invisible road illumination and imaging, where gate of road imaging system is synchronized with timing signal acquired from triggering electromagnetic pulse of oncoming vehicle.

FIG. 4 is substantially schematic representation of illuminating and triggering pulses positioned in time for one vehicle and temporal behavior and activation of image detector gate of second oncoming vehicle moving towards the first one.

### DRAWING REFERENCE NUMERALS WORKSHEET

101—road illuminating pulsed source of light,

102—trigger, which is used to activate illuminating source of light and gate of image detector,

103—synchronizing unit, producing timing signal for triggering unit,

104—receiver and processor of timing signal from global positioning system satellites,

105—display,

106—image converter,

107—image detector with fast gate,

108—lens assembly for acquiring image of the road,

109—wavelength selective filter,

110—schematic view of road illuminating electromagnetic radiation and direction of its propagation

201—first road illuminating pulse from first group of vehicles,

202—second road illuminating pulse from first group of vehicles,

203—third road illuminating pulse from first group of vehicles,

204—arbitrary N-th road illuminating pulse from first group of vehicles,

205—graph showing illuminating pulses from first group of vehicles versus time,

206—graph showing illuminating pulses from second group of vehicles versus time,

207—graph showing illuminating pulses from third group of vehicles versus time,

208—graph showing illuminating pulses from arbitrary N-th group of vehicles versus time,

209—position in time scale predetermined antitheft time zone,

210—direction of time,

211—time interval between pulses T_{PR},

212—time interval showing approximate relative duration of idle interval ΔT_{IDLE},

213—time interval showing approximate relative duration of laser pulse ΔT_{PULSE},

214—hatched area showing approximate relative duration of time interval when imaging device is activated to be in working mode ΔT_{GATE},

303—synchronizing and processing system,

310—receiver of electromagnetic radiation of triggering pulse,

311—wavelength selective filter transparent for electromagnetic radiation of triggering pulse,

312—generator and illuminator of triggering electromagnetic pulse,

313—schematic view of triggering electromagnetic radiation and direction of its propagation,

401—triggering pulse,

402—illuminating pulse,

403—graph showing illuminating and triggering pulses versus time from first vehicle,

404—graph showing when image detector of second oncoming vehicle is activated and shut down,

405—first double pulse,

406—second double pulse,

407—third double pulse,

408—N-th double pulse

409—time intervals showing when image detector is shut down,

410—time intervals showing when image detector is activated,

### DESCRIPTION AND OPERATION OF THE PREFERRED EMBODIMENTS.

The following detailed description, which describes only preferred embodiments of the invention, is understood only to be an illustration of the best mode contemplated of carrying out the invention. As will be realized, the invention is capable of other and different embodiments, and its several details and methods are capable of modifications in various obvious respects, all without departing from the invention. Accordingly, the drawings and description are to be regarded as illustrative in nature, and not as restrictive. Two preferred embodiments of the invention are described further.

First Embodiment.

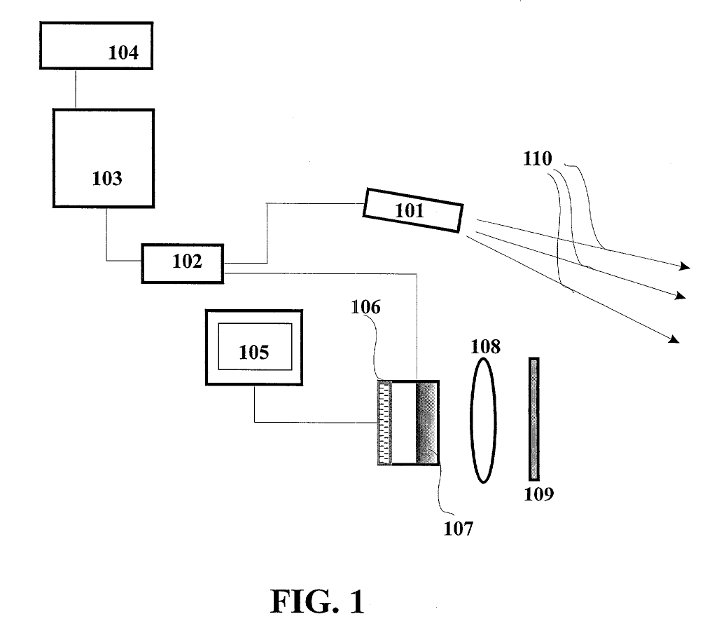

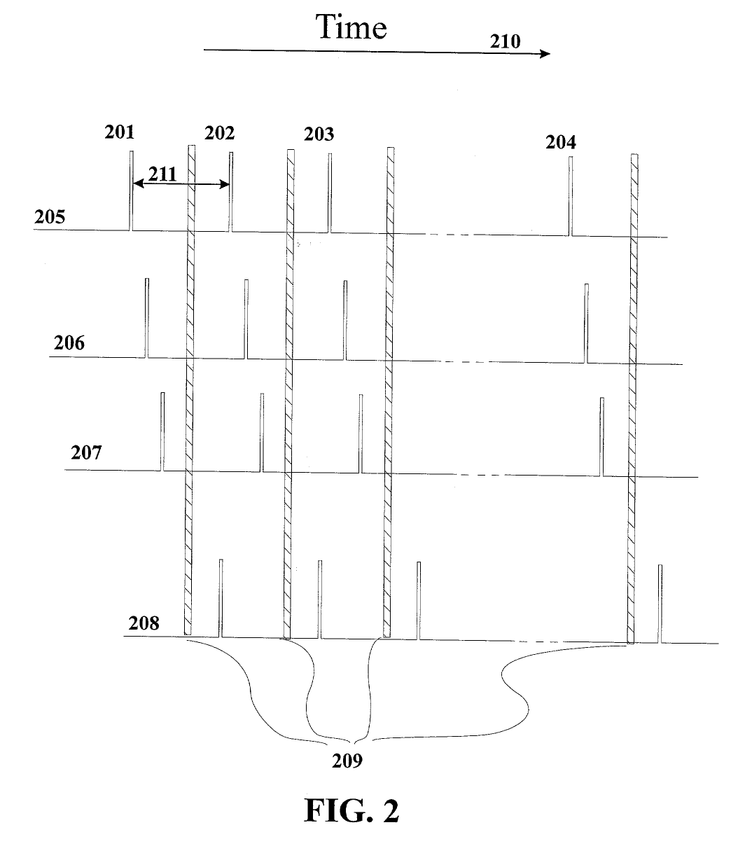

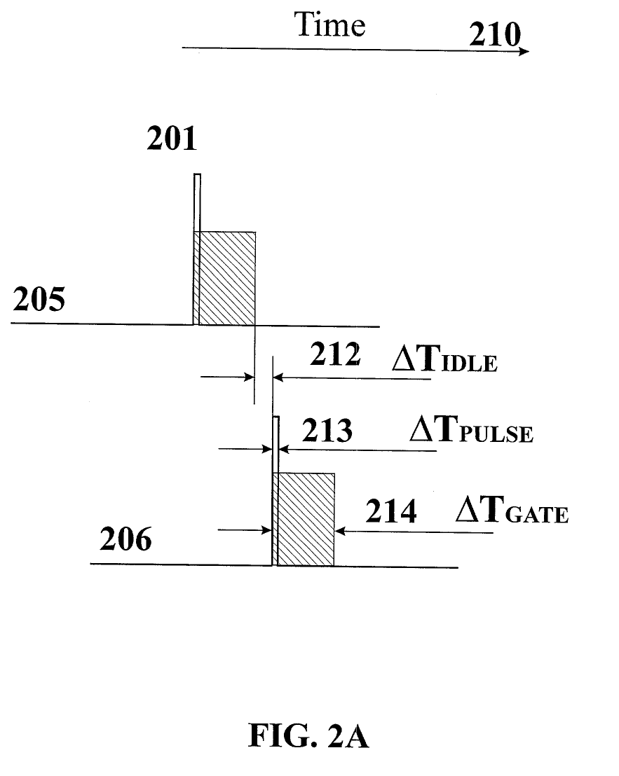

The description of this embodiment and the principles of operation of the invention can be understood from FIGS. 1, 2 and 2A. A pulsed road illuminating source of light 101 is used as a headlight of a vehicle and its radiation 110 is directed towards a direction of a vehicle movement to illuminate the road. If laser is used as a light source 101 its output may be homogenized via a fiber optic or light pipe or other such mean as known by those skilled in the art to uniformly illuminate the target area. The repetition rate of the pulses of the device 101 may be more than reciprocal time of eye inertia, preferably more than 5 Hz, although any rate can be used. The device 101 may be any type of pulsed source of light (for example: laser, pulsed arc discharge xenon lamps, electrodeless discharge lamp, light emitting diode etc.) illuminating in the invisible for human eye spectrum about 0.19-0.45 and 0.7-5 μm. The spectral range of road illuminating device 101 may be in any out of visible region of spectrum, but to provide high quality image it works in the region of spectrum with wavelength shorter than 5 μm. The duration of the illuminating source 101 pulse ΔT_{PULSE}may be chosen from very short (several femtosecond) to rather long (several microsecond). In any case it is shorter than about ΔT_{PULSE}=D_{S}/c (where c is the speed of light; D_{S}−a distance which needs to be illuminated and observed in front of the vehicle). Exactly at the time when illuminating device 101 shoots the light pulse a trigger 102 turns on an imaging device with fast gate 107, which should be gated with time duration of a gate equal to about ΔT_{GATE}=(2D_{S}/c)+ΔT_{PULSE}. One of the preferred embodiment for image detector 107 is resonance ionization image detector (RIID), image intensifier with or without micochannel plate or electron bombardment CD. In this description gated means activated for a short period of time, to be in working condition, and to be ready to acquire imaging information from the road. It is understandable the shorter the gate ΔT_{GATE}the less probability to acquire and less intensity of a glare from oncoming vehicles. The value of ΔT_{GATE}in any case is not set out to be less than 2D_{S}/c, due to well known limit for the speed of light. The only figure, which may be changed, is ΔT_{PULSE}and to provide the influence of ΔT_{PULSE}negligible on duration of ΔT_{GATE}the value of pulse duration is chosen to about D_{S}/c or less.

The trigger 102 is used to provide synchronizing pulses to activate the road illuminator 101 and the gate of image detector 107. If laser is used as illuminating device it may be, for example, the synchronizing-pulses to trigger its Q-switch element, pulsed semiconductor laser or pumping laser if it is used simultaneously with pumped tunable laser. The synchronizing pulse for trigger 102 is acquired from the synchronizing unit 103. Thus trigger 102 is connected with the synchronizing unit 103, with the road illuminating source of light 101, and with image detector 107. The device 102 is used to gate image detector 107 synchronously with light pulse from illuminator. The image of the road is captured further by an image converter 106, which may be CCD, CID or CMOS camera equipped with corresponding digitizing or analog converter. Image of the road may be observed by a driver from a display 105 connected to the image converter 106. The display 105 may be any type of display convenient in a vehicle cabin for example microdisplay, which uses OLED-on-silicon technology (S. K. Jones, W. E. Howard, “OLED/CMOS combo opens a new world of microdisplay”, Laser Focus World, December 2001, p.55-58) or head-mounted display, The image of the road on the image intensifier surface is formed by a lens assembly 108. The lens assembly 108 is constructed to be capable of projecting a sharp or in focus image.

A wavelength selective filter 109, which may be color glass, acousto-optic, Liot type, atomic resonance fluorescence imaging monochromator, atomic or molecular magneto-optical (Faraday, Voigt) filter, low or high resolution interference filter and any other spectrally selective imaging filters, is used to block all other radiation, except radiation with spectral composition of road the illuminator 101. Also, instead of filter 109 with image intensifier 107 resonance ionization image detector (RIID). (see for example J. D Winefordner, I. B. Gornushkin, D. Pappas, O. I. Matveev, B. W. Smith, “Novel uses of lasers in atomic spectroscopy”, J. Analytical Atomic Spectroscopy, V.15, 2000, p. 1171-1179) may be used. In the case when RIID (or any other atomic monochromators, filters or detectors) are used the illuminator 101 should have narrowband output and tuned to the wavelength to which RIID is sensitive. For example if cesium, rubidium or potassium atomic vapor is used in a RIID cell, the illuminator 101 has to be tuned to one of the resonance transitions of these atoms with wavelengths 894.35, 852.11, 794.76, 780.02, 769.90 and 766.49 nm correspondingly.

Parts of the road illuminating system described above including devices 101, 105, 106, 107, 108, and 109 are well known for many military applications and they are working similarly with military target illuminating system described, for example, in the U.S. Pat. No. 5,383,200 or in a paper written by Verle Aebi and Peter Vallianos, “Laser-illuminated viewing provides long range detail”, Laser Focus World, September 2000, p.147-150. Quality of the image, which may be reached by this system, can be much higher in comparison with thermal IR cameras since shorter wavelength 0.19-0.45 and 0.7-3 μm may be used to detect an image. For these regions of spectrum there exists or is under development fast image intensifiers with total spatial resolution of more than 1 million pixels. For certain wavelengths and for the certain conditions if image converter 106 is sensitive enough to detect image without image intensifier 107 then fast light shutter (for example Kerr or Pockels cell) may be used, which will be open only during ΔT_{GATE}time.

In accordance with the present invention to eliminate the glare from the oncoming traffic its source of light 101 has pulses synchronized in a way that from different groups of vehicles pulses will appear at different time zones as shown in FIG. 2. Diagrammatically, in FIG. 2 first 201, second 202, third 203 and arbitrary N-th 204 road illuminating pulses for first group of vehicles 205 are shown with respect to corresponding pulses from second 206, third 207 and N-th 208 groups of vehicles. Also direction of time 210 is shown. As seen in FIG. 2 the pulses from different groups of vehicles are shifted in time, and due to this the process of road illumination, image detection will take place also in different time zones. The duration of one time zone T_{Z}is defined as T_{Z}=ΔT_{GATE}+ΔT_{IDLE}. The number of time zones NT_{Z}is equal T_{PR}/T_{Z}(where T_{PR}is shown in FIG. 2 time interval 211 between road illuminating pulses. Ideally, when very fast gate and very short laser pulse is used the NT_{Z}will be equal T_{PR}/ΔT_{GATE}. The expanded schematic representation of illuminating pulses 201 positioning in time for two groups of vehicles assigned to two closest to each other time zone are shown in FIG. 2A. In this figure approximate relative duration of laser pulse 213 (ΔT_{PULSE}) and gate duration 214 (ΔT_{GATE}) are shown. The idle interval ΔT_{IDLE}212 is defined as predetermined time intervals during which no one VFSI is permitted to fire laser pulse and the gates of imaging systems to observe the road for all VFSI are closed. The abbreviation VFSI (vehicle with fast synchronized imaging and illuminating system) means the vehicles, which have the same type of device for invisible road illumination, with same wavelengths for road illuminating light source.

The illuminating pulses for different vehicles are not only precisely shifted one from another but also have very precise period T_{PR}between them (see FIG. 2). The time shift of the pulses for different groups of vehicles is the same for a whole long period of time, while illuminating system is working. The synchronization of pulses for different vehicles is accomplished using a signal from the US GPS (Global Positioning System) and/or the Russian GLONASS (GLObal NAvigation Satellite System) or any another global positioning system deployed in the future. The inventions described herein are not to be limited to the specific GPS devices disclosed in the preferred embodiments, but rather, are intended to be used with any and all such applicable satellite timing signal providing devices, systems and methods, as long as such devices, systems and methods generate input signals that can provide required precision of timing signal. These timing signals are acquired from a receiver and time signal processor 104, which is connected to the synchronizing unit 103. Also predetermined combination of signals from several different global positioning systems may be used. According to data from U.S. Naval Observatory (USNO) GPS time is automatically steered to Coordinated Universal Time (UTC) on a daily basis to keep system time within one microsecond of UTC(USNO), but during the last several years has been within 50 nanoseconds. The rate of steer being applied is +/−1.0E-19 seconds per second squared. Since the deactivation of the Selective Availability program on May 2, 2000, most GPS commercial receivers now produce a 1 pulse per second output with a standard deviation of 10 ns or less. Many receivers produce frequency with an uncertainty of <1×10⁻¹² when averaged for one day. Two key factors that contribute to receiver 104 performance are the quality of the receiver's internal oscillator, and the quality of the software algorithms that process data acquired from the satellites. For simplified embodiments of this invention synchronization from WWVB federal government radio stations in Fort Collins, Colo., which continuously broadcasts time and frequency signals at 60 kHz, may be acquired. The carrier frequency provides a stable frequency reference traceable to the national standard. There are no voice announcements on the station, but a time code is synchronized with the 60 kHz carrier and is 3 broadcast continuously at a rate of 1 bit per second using pulse width modulation. The time code contains the year, day of year, hour, minute, second, and flags that indicate the status of Daylight Saving Time, leap years, and leap seconds (see web site http://www.boulder.nist. gov/timefreq/stations/wwvb.htm). Also the timing signal may be received from two another radio stations: one of them WWV broadcasts on 2.5, 5, 10, 15, and 20 MHz from Fort Collins, Colo., and another one WWVH broadcasts on 2.5, 5, 10, and 15 MHz from Kauai, Hi. Both stations continuously broadcast a timing signal-24 hours per day, 7 days per week to listeners all over the world. However, the timing signal from these three radio stations is not as precise and reliable as the signal from GPS.

To illustrate advantages of this invention let us assume that the pulse of the illuminator has duration ΔT_{PULSE}=200 ns, ΔT_{IDLE}is much shorter than ΔT_{GATE}, the road should be illuminated at the distance D_{S}=300 m, and the repetition rate of the pulses R_{c}is 25 Hz. In this case, the probability Pₘto meet oncoming car, which illuminates the road at the same time as yours will be about Pₘ=ΔT_{GATE}R_{c}=(((2×300)/3 10⁸)+200 10⁻⁹)25=5.5 10⁻⁵. I.e. approximately 1 out of 18181 cars will illuminate the road within the same time zone as yours. If the average rate to meet a car with the same type of illuminator with randomly selected time frame for road illumination will be R_{M}, the probability to be blinded at least once during the trip with duration T_{TR}will be determined by formula

Pₘ=βT_{GATE}R_{c}T_{TR}R_{M} (1)

It is not difficult to estimate that depending on the traffic intensity or where one lives whether it is a big or a small town even if all vehicles will be equipped with this invisible road illuminating system the probability to meet the oncoming vehicle illuminating in the same time zone may be not more than 1 in one day. In a case if one even meets such a vehicle, which illuminates within the same time interval the tactics would be the similar to when one should turn from high beam light to low beam. The only thing is that this event would be much more rare than under normal car driving conditions when a driver on highways or in a town practically always has to drive using only low beam light. It should be noted that if the pulses are not synchronized precisely the formula (1) will be different and in case of randomly or not adequately synchronized pulses the probability Pₘshould be multiplied by the number of pulses N illuminated by a car during their movement towards each other. This number N can be determined by formula N=[D_{S}/(v₁+v₂)]R_{c} (where v₁+v₂ is mutual velocity of two cars towards each other). From this reasoning it is understandable that if illuminating pulses of cars are not synchronized precisely, the probability Pₘwill always depends on the number of pulses N, i.e. depends on the time while the cars are moving distance D_{S}towards each other. Depending on mutual velocity of cars the N number may vary from 100 to 1000. This means that using provided here invented system (based on GPS or/and GLONASS signals) for pulses synchronization the probability to be blinded by oncoming car will be 100-1000 times less than when random or not adequately synchronized pulses are used to illuminate the road.

It is understandable that invented here system for road illumination will work only if all cars synchronously shoot the light pulses only within predetermined and assigned for them time zone. As it was mentioned the period between illuminating pulses is divided on predetermined number of time intervals with predetermined duration of each interval. Each predetermined time interval may be assigned for predetermined group of vehicles, for example, for military, government, low enforcement, ambulance, fire rescue, tracks, luxury vehicles, small big vehicles etc. The precision of pulses synchronization depends on how precisely the period between pulses T_{PR}is set. This precision is defined to be as a sum of systematic and random error and it has to be equal or less to duration of idle interval, divided by time, which is necessary for vehicle to travel illuminated distance in front of the vehicle. It has to be at least less than the ratio of ΔT_{IDLE}/TS (where Ts is the time which is necessary for vehicle to travel the distance D_{S}with predetermined threshold velocity). The threshold velocity for a vehicle with standard factory headlights is defined as minimal velocity for which if exceeded the probability to be involved in an accident becomes more as compared for a vehicle which is equipped with a system for invisible road illumination. In practice this velocity varies depending on many circumstances and is projected to be about 10 to 20 mph. Practical value for ΔT_{IDLE}is set depending on the type of a model and price affordable for customers of a VFSI. This time interval may be from about several nanoseconds to about several milliseconds. It is understandable, if repetition rate of pulses is fixed, the required precision to set time interval between the illuminating pulses is always linear versus ΔT_{IDLE}. However the number of independent time zones N_{Z} depends nonlinearly on ΔT_{IDLE}.

N_{Z}T_{PR}/(ΔT_{GATE}+ΔT_{IDLE}) (2)

From the formula (2) it is clear that if ΔT_{IDLE}is set less than 10-20% from ΔT_{GATE}this does not provide practically more independent time zones, however it will lead to considerable technical complexity for the whole imaging system. Thus if optimal practical value for ΔT_{GATE}equal 1-2 μs optimal ΔT_{IDLE}may be equal about 100-400 ns and required precision to set time interval T_{PR}has to be less than about 1.3 10⁻⁸-3 10⁻⁹. Such a precision can be reached, for example, by atomic clocks.

It is evidently that it is impractical to relay in this case on the idea to install in every car very expensive high precision atomic clocks. However, at modern time this task can be solved much more simple. The most convenient system for pulse synchronization, as we mentioned, is the US GPS or/and the Russian GLONASS. As known (see for example http://www.gpsworld.com/0499/0499feat.html an article “GPS+GLONASS: TOWARD SUBNANOSECOND TIME TRANSFER” by Wlodzimierz Lewandowski from Jacques Azoubib Bureau International des Poids et Mesures) using GPS and GLONASS the precision of time measurement can be reached in subnanosecond region what is understandable two-three order of magnitude better than it is necessary for our system to work effectively. Variety of GPS signal based time synchronizing systems are available at the market with precision from 2000 to 10 ns (see for example the products catalog of TrueTime, Inc., 3750 Westwind Blvd., Santa Rosa, Calif. 95403; www.truetime.com). Important thing is that using GPS and/or GLONASS one can know precisely not only the absolute (UTC) time but also his 3D coordinates on the Earth. Thus the system providing invisible light road illumination simultaneously can provide very precise positioning service for a driver of a vehicle simultaneously. Recently, on May 1, 2000 the US President Bill Clinton announced a statement about the US decision to stop the degradation of US global position system accuracy. Better accuracy means also higher potential value for this invention, since precision of synchronization and driver's positioning will be much better determined. In FIG. 1 as seen the receiver of the GPS signal 104 is connected with synchronization system 103 to provide precise synchronization of illuminating pulses with GPS or/and GLONASS system and also to provide the road image detection simultaneously with road illumination.

Since the timing signal from GPS is precisely coordinated with UTC, additional important features is provided by this invention. The pulsed vehicular system for invisible road illumination and imaging may simultaneously serve as an efficient antitheft system. It may be realized in many ways. For example, if a thief does not use a special key to ignite a car engine, or does not enter a password the synchronization system 103 connected with the key electronic system (not shown in FIG. 1) will give quasi-random signal for trigger. In this case, a stolen car will be immediately seen by every driver since it will produce visible for everyone random or quasi-random pulses. Another ramification is provided when synchronization system switches the pulses (still synchronous) to some specially predetermined time zone 209 (see FIG. 2). To check the road every driver can switch his car to this time zone in a mode of image detection and also the road can be checked by police patrol car or a helicopter with fast synchronized illumination and imaging system. From the helicopter stolen cars can be immediately seen at the distance of several kilometers even at daytime. The third ramification of antitheft system is the following: every car from the moment when it is bought by random choice or according to predetermined time zones allocation schedule is assigned to the certain time zone and during the whole lifetime of the car it will illuminate only within that time zone. Let us say a group of vehicles # 1 will always illuminate its first pulse of the day at 00 hour 00 minutes and 0.000000001 second. Every day number of pulses in this case has to be equal to the same number of integers. Stolen car can be found by simply checking from helicopter for example all cars illuminating within that time zone. Instead of checking all cars one out of 10-15 thousands car have to be checked.

Another methods to decrease the probability of danger from the glare of oncoming traffic can be realized by using car headlights producing radiation in different spectral range. Minimal frequency interval which is required for the imaging system to work can be estimated from data on a Doppler frequency shift of laser line for maximum velocity of cars moving towards each other and also from the Fourier transformed spectral width of short pulses used in illuminator 101. Theoretically, depending on the pulse temporal shape and duration, if, for example, one uses illuminator pulses with duration 10 ns the spectral width of the region where radiation from different cars can be well enough distinguished by spectrally selective imaging device will be less than 100-300 MHz. The Doppler shift of the line can be , estimated assuming maximum velocity about V=100 miles/hour. It may be estimated that, for example, for infrared region of spectrum 700-1500 nm this bandwidth can be Δv=v(V/c) (where c is the speed of light) 127.7 and 59.6 MHz correspondingly.

Since resolution R by definition equal λ/Δλ it is not difficult to derive that required resolution in our case has to be R=V/c or 7 10⁷. Taking in to account that area of image detector has to be at least 3-5 cm² and the field of view 1-2 sr it can be estimated that ideally luminosity-resolving power product (LRPP) to image moving car with very narrowband laser illuminator has to be 10⁷-10⁸ cm² Sr. The only imaging devices which can provide such a big LRPP (see, for example, O. I. Matveev, B. W. Smith, N. Omenetto, J. D. Winefordner, “Relevance of the luminosity-resolving power product for spectroscopic imaging”, Appl. Spectroscopy, 53, No 11, p.1341-1346, 1999.) are

1) atomic and/or molecular vapor ultranarrowband image detectors including but not limited resonance atomic and/or molecular fluorescence monochromators (see, for example,

O. I. Matveev, B. W. Smith, J. D. Winefordner, “Ultra-narrowband resonance ionization and fluorescence imaging in a mercury atom vapor cell”, Optics Letters, V.23, N 4, p.304-306, 1998);

2) resonance atomic and/or molecular ionization image detectors (see, for example,

O. I. Matveev, B. W. Smith, J. D. Winefordner, “Resonance ionization image detectors: basic characteristics and potential applications”, Applied optics, V.36, N34, p. 8833-8843, 1997;

J. D. Winefordner, O. I. Matveev, B. W. Smith, “High resolution resonance imaging detector and method”, U.S. Pat. No. 6,008,496,1999;

J. D Winefordner, I. B. Gomushkin, D. Pappas, O. I. Matveev, B. W. Smith, “Novel uses of lasers in atomic spectroscopy”, J. Analytical Atomic Spectroscopy, V.15, 2000, p. 1171-1179);

3) atomic and/or molecular magnetooptical filters (see, for example,

B. Yin, T. M. Shay, “Theoretical model for a Faraday anomalous dispersion optical filter”, Optics Letters, V.16, No 20, 1991, p.1617-1619.

R. I. Billmers, S. K Gayen, M. F. Squicciarini, V. M. Contarino, W. J. Scharpf, D. M. Allocca, “Experimental demonstration of an excited-state Faraday filter operating at 532 nm”, Optics Letters, V.20, No 1, 1995, p.106-108.

E. Dressler, A. E Laux, R. I. Billmers, “Theory and experiment for the anomalous Faraday effect in potassium”, Journal Optical Society of America, V.13, No 9, 1996, p.1849-1858.

B. P. Williams, S. Tomczyk, “Magneto-optic Doppler analyser: a new instrument to measure mesopause winds”, Applied Optics, V.35, No 33, 1996, p.6494-6503).

4) spectral hole burning filters (see, for example,

W. E. Moerner. Ed. “Persistent spectral hole-burning: science and applications”, Springer Verlag, Berlin, 1988.

B. S. Ham, M. S. Shahriar, P. R. Hemmer, “Enhanced nondegenerate four-wave mixing owing to electromagnetically induced trancparancy in a special hole-burning crystal”, Optics Letter, V.22, No 15, 1997,p.1138-1140.

H. Hemmati “Narrow-band optical filters made by spectral hole-burning”, NASA Tech Brif, August, 1997, p.54.

In book Trends in Optics, A. Consortiny Ed. Academic Press, San Diego, A. Rebane, “Femtosecond time-and-space-domain holography”, 1996, p.165-188.

K. Fujita, K. Tanaka, K. Hirao, N. Soga, “Room temperature persistent spectral hole burning of Eu 3+ in sodium alumosislicate glasses”, Optics Letters, V.23, No 7, 1998, p.543-545).

In the case when RIID (or any other atomic monochromators, filters or detectors) are used the illuminator 101 should have narrowband output and tuned to the wavelength to which RIID is sensitive. For example, if cesium, rubidium or potassium atomic vapor is used in the cell of RIID, the illuminator 101 has to be tuned to one of the resonance transitions of these atoms with wavelengths 894.35, 852.11, 794.76, 780.02, 769.90 and 766.49 m correspondingly. As an example, we will describe the method of selective Cs atoms ionization and noise free image creation for Cs RIID cell. This method is applicable for RIID cells with any other atoms. As known (see, for example, review by O. I. Matveev, “Atomic resonance spectrometers and filters”, Journal of Applied Spectroscopy (Russ.), V.46, No 3, 1987, p.359-375) the main type of noises in a RIID cell are caused by nonselective multiphoton ionization of atoms and molecules, photo electric effect from the RIID surfaces. At the beginning Cs atoms in the RIID cell absorb λ₁ resonance radiation containing imaging information about the road. Simultaneously with λ₁ the cell is illuminated by 2 radiation to excite atoms further into predetermined Rydberg states which have a lifetime about ΔT_{GATE}. For example if λ₁ radiation for Cs atoms equal 852.11 nm, the wavelength of 2 radiation for Cs atoms has to be about 535-510 nm. The gate function for this RIID in this ramification is executed by λ₂ laser radiation I.e. when λ₂ is illuminating the RIID cell it correspond to the situation as if gate turned on. Due to this the duration of λ₂ laser pulse is set equal also to ΔT_{GATE}. To eliminate the noises, mentioned above, after gate is closed small first pulsed predetermined voltage with predetermined duration is applied to electrodes of RIID cell in order to remove all noise electrons and ions. For the design of the RIID cell without MCP this may be voltage about 10-1000 V, which is not enough to ionize Cs atoms excited into the Rydberg states, and with pulse duration about 10-500 ns. After first voltage pulse second voltage pulse is applied with predetermined voltage to ionize atoms excited into the Rydberg state. Second pulse has normally voltage more than 1000 V up to 50 kV. This second voltage pulse accelerates electrons or ions towards phosphor (or any other position sensitive to charged particles) screen to produce image of the road. Also the atoms excited into the Rydberg state may be ionized after the gate is closed by delayed pulsed laser radiation, for example, 1064 nm Nd:YAG laser.

The closest to this LRPP among well established spectrally selective filters is for acoustooptic filters with only approximately 3 10³ cm² sr, i.e. almost tree four orders of magnitude less. If one uses the imaging device with such a big LRPP one-two order of magnitude illuminating laser power will necessary to eliminate image distortions, noises and glare from oncoming vehicles, or to limit field of view; that means the amount of information from road imaging device. Ultranarrowband, with high LRPP value image detector may provide, in principle, additional considerable improvement figures of merit for the imaging system. If, for example, imaging device with a bandwidth approximately 300 MHz is used in the eye safe spectral range 1.52-1.76 μm almost 90,000 independent spectrally separated channels may be provided to decrease the probability for driver to be blinded by oncoming traffic. Thus, the total probability to meet a car working in the same time zone and at the same frequency will be 1/(90000×1818)=6 10⁻¹⁰. It is understandable that reciprocal number of this probability is at least three orders of magnitude more than total number of cars on the Earth

Thus imaging device with high LRPP has four advantages:

1. Increased number of spectrally separated channels.

2. Substantially decreased brightness and noise from images of standard factory headlights of oncoming vehicles.

3. Requirements for illuminating laser (or any other source of light) pulse energy and average power are two-three orders of magnitude less.

4. When population of VFSI will become several millions in several years if not regulated by the Federal Communication Commission (FCC) the vehicles will illuminate laser radiation of different frequencies into different arbitrary direction creating considerable interferences for each other. Thus in several years unavoidably the FCC will expand the spectrum (which is from 9 kHz-300 GHz at present) where their rules and regulations applied to infrared and may be optical part of the spectrum. The regulation imposed on the infrared spectrum means that if broadband illuminating source of light is used much higher price has to be paid for this privilege. In this case the imaging devices with high LRPP will become economically more attractive.

Second Embodiment.

To increase reliability for the whole system also for the most demanding type of vehicles like police, ambulance, fire rescue additional improvement is included. For these purposes an additional generator is included, triggering electromagnetic pulse with electromagnetic frequency of its radiation different in comparison with road illuminating pulse. This additional triggering pulse is generated before road illuminating pulse with predetermined and the same for all vehicles time difference. The radiation from the additional generator is directed in the same direction as laser pulse from illuminating pulsed laser.

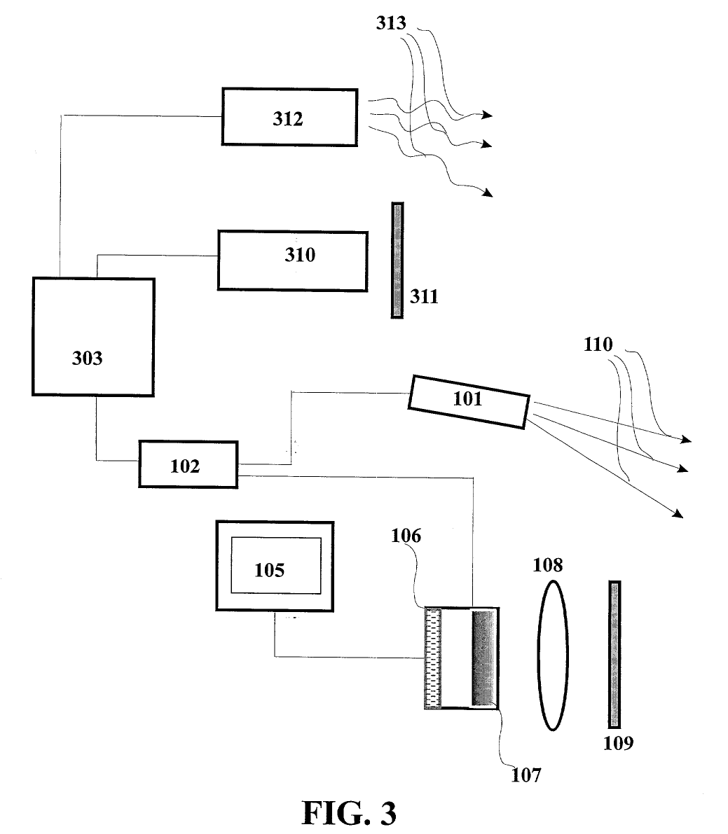

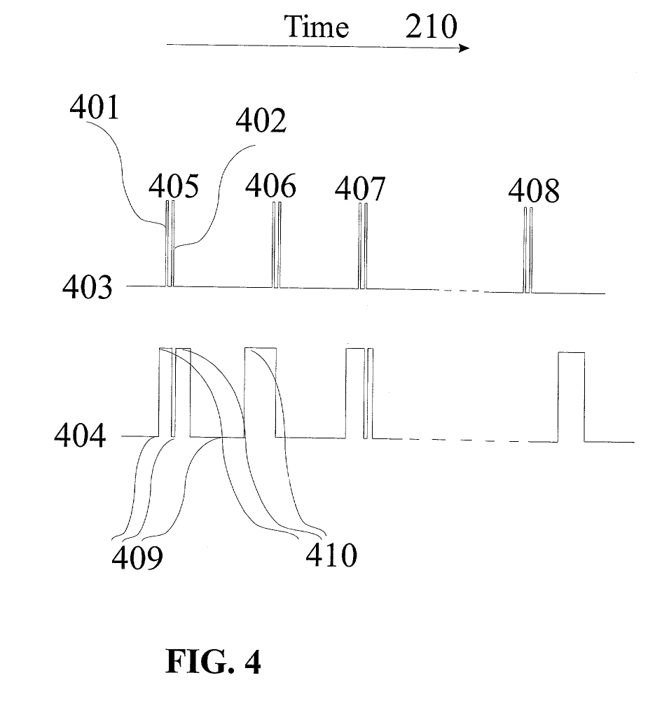

The technique described above can be called an ultra fast synchronized imaging technology Thus another preferred embodiment of ultra fast synchronized vehicular imaging system with invisible headlights is provided by this invention. The principle of operation can be understood from FIGS. 3 and 4. In comparison with the first embodiment of this invention, the synchronization of the road illumination and imaging will be performed in some different way. The main idea of this embodiment is to close the image intensifier for a short period of time when it sees an illuminating pulse from the oncoming car. For this version of the invention the duration of illuminating pulse from illuminator 101 should be much shorter than for the previous version. It is chosen to be in the interval 1-300 ns or less. Let us assume that two vehicles or cars #1 and #2 are moving on the road in the opposite directions towards each other. Every car has similar system for the road illumination and for road imaging. The car #1 sends two closely disposed pulses triggering 401 and and illuminating 402 as shown diagrammatically in FIG. 4. Further in the text these two closely disposed pulses will be defined as double pulse. The triggering pulse is generated by the illuminator or generator of optical or RF triggering pulse 312. The electromagnetic radiation 313 from the generator 312 is aimed in the same direction as road illuminating pulse radiation 110. When such a short (1-300 ns) illuminating pulse is used the necessity to have shifted in time triggering pulse is dictated by the fact that it is practically impossible to close the gate of image intensifier 107 immediately at the same time when blinding pulse from the oncoming car arrives. The time interval (which can be about from several nanoseconds to several microseconds) between these two pulses is predetermined and it is set exactly the same for all double pulses and for all cars. Let us say this time interval between illuminating and triggering pulse is about 400 ns. By firing triggering pulse the car # 1 produces kind of warning that in 400 ns illuminating pulse will be fired. This first pulse passing via wavelength selective filter 311 is detected by a photon or RF signal detector 310 of car #2, then sent to a synchronizing unit 303 which sent out a pulse with predetermined pulse delay. The synchronizing unit 303 is connected to generator 312, receiver of triggering electromagnetic pulse 310, and to the trigger 102. After unit 303 pulse goes to trigger 102, which closes the gate 107 of imaging device exactly at the time, when illuminating pulse from oncoming vehicle #2 arrives. The gate becomes closed only during the time equal to the illuminating pulse duration.

In FIG. 4 track 403 schematically represents illuminating and triggering pulses of car #1 versus time and track 404 shows when imaging device of car #2 is activated or shut down. The first, second, third and N-th pulses are denoted in FIG. 4 as 405,406,407, and 408 correspondingly. When the road illuminating pulse from the car #1 arrives to the car #2 the gate of its the image intensifier becomes closed as seen in FIG. 4. Points 409 and 410 schematically represent time intervals where the gate of image detector is closed and open correspondingly. The terms used here gate is closed means that the image detector 107 is shut down and does not acquire any images, the term gate is open means detector 107 is activated and acquire the image. For example, let us assume that the gate of the image intensifier is open during about 2 μs and the duration of the pulse illuminating the road is 1 ns. This means that a part of the road of only 15 cm long out of 300 m will be partially invisible for a driver. If a car is moving with a velocity 20 m/s and repetition rate of the pulses is 25 Hz with every new pulse absolutely new sector of the road will be invisible since between two illuminating pulses car shift will be 0.8 m. The next pulse will travel to the same point on the road let us say 299.2 m instead of 300 m. Even if duration of the illuminating pulse is 10 ns (not so perfectly visible part of the road will be 150 cm) some part of the road is not seen only during two pulses. It is evidently that even in the last case (10 ns pulse duration) the image quality of the road for average driver will not be deteriorated significantly or may be even noticeably.

However, the electronics for of 1 or even 10 ns gate is rather expensive and sophisticated. To make device cheaper another embodiment of invention is provided. For this last embodiment even the road illuminating pulses with the length 10-20% from the total duration of the image acquiring time (i.e. 200-400 ns) are used if double pulses (triggering and illuminating) will be fired not exactly synchronously but quasi-synchronously. Quasi-synchronously in our case means that if average duration between double pulses will be the same, let us assume tp=40 ms, the position of the double pulse will be random within an interval t_{R} about 0.1-2 ms. Diagrammatically, as seen in FIG. 4 the distance between first and second pulse is not equal to the distance between second and third pulse. Generally, when within certain period of time the distance between the double pulses for one car is different than for another, but average period is the same, they are considered as quasi-randomly generated.

It is evident, to prevent the penetration of illuminating pulse from illuminator 101 into the channel of triggering pulse initiation (i.e. to the pulsed electromagnetic energy receiver 310) they should be separated spectrally. For example, it is done using filter 311 as shown in FIG. 3, which is tuned to a different wavelength of electromagnetic radiation in comparison with filter 109. It is worth mentioning that triggering pulse does not necessarily have to be produced in the optical region of spectrum. It may also be in the radio-frequency region. If for example, the wavelength of the illuminating pulse is within the 1.52-1.76 μm spectral range, the triggering pulse should be out of this spectral range and even can be in a radio-frequency range. The device 310, which is photon or radio frequency signal detector, is used only to detect the triggering signal from oncoming traffic.

The probability for this version of road illuminator and light detector to catch at least one blinding (glare) pulse within the time zone when the gate of the image intensifier 107 is open can be determined by formula

$${P}_{m} = Δ {T}_{GATE} {R}_{c}^{2} \frac{{D}_{S}}{{V}_{C}} {T}_{TR} {R}_{M} \qquad ( 3 )$$

where V_{C}−velocity of cars moving towards to each other. I.e. V_{C}=velocity of car #1 plus velocity of car #2; D_{S}is the safety distance from which blinding action of illuminator can be considered negligible or the distance at which the road is illuminated. According to Florida defensive driving rules, for example, their high-beam headlights can not be used within D_{S}=150 m from oncoming vehicles. To illustrate advantages of this invention embodiment this distance to be assumed D_{S}=300 m.

As seen, in comparison with formula (1) the probability Pₘfor second version of fast imaging system is R_{c}D_{S}/V_{c} times bigger. However, it is evident for somebody who is skilled in the art, if not so many light pulses penetrate during the time when image is detected ΔT_{GATE}≈1-2 μs and image intensifier will be closed only during short period of time ΔT_{PULSE}≈1-20 ns, practically no harm to image quality occurs. Let us analyze the ultimate situation when a vehicle is moving along 6-line highway with intense traffic. If the distance between the cars is approximately 30 m the road is seen by imaging device 107 only 2 μs in the field of view of the imager there are always N_{C} approximately 30 oncoming cars producing its own road illuminating radiation pulses with repetition rate, let us say, 25 Hz. Using formula (3) it is not difficult to calculate that for every image detecting frame the average rate to catch at least one pulse within one time frame when image intensifier is supposed to detect image of the road is S_{AV}=ΔT_{GATE}R_{C}N≈1.5 10⁻³ per pulse. If we assume that short blinding pulses from oncoming car are considered as a random event the probability P_{D}for this version of invention to acquire during ΔT_{GATE}×=1, 2, 3. . . etc pulses can be determined by the Poisson probability distribution formula

$${P}_{D} = \frac{{S}_{AV}^{x} exp ( - {S}_{AV} )}{x !} \qquad ( 4 )$$

It is not difficult to calculate that for x=2 P_{D}=1.1 10⁻⁶ and for x=3 P_{D}=56 10⁻¹⁰. The magnitude P_{D}=1.1 10⁻⁶ means that traveling for 10.1 hours [T_{TR}=1/(P_{D}R_{c}3600)=1(1.1 10⁻⁶ 25 3600)=10.1] during nighttime along the 6-line high highway with maximum possible intensity of traffic when all oncoming car have the same pulsed illuminating system one can catch only one blinding double pulse during the period ΔT_{GATE}. Thus it is understandable that the system for elimination the blinding light from oncoming cars may be designed to eliminate only one pulse.

The system for pulses synchronization 303 is used to sent (for example 400 ns earlier) a pulse to the generator of triggering pulses 302 and also to acquire the triggering pulses from photon or RF signal detector 310 and transfer them to trigger 302. That means the trigger 102 produces two type of pulses: one of them to initiate the illuminator 101 and another one to gate the image intensifier 107 after receiving corresponding pulses from the system 303.

It needs to be mentioned both embodiments, indicated as first and second of this invention can coexist together and can be installed both into one vehicle and also separately into different vehicles. However, to eliminate the interference from each other they should work at different wavelengths. For example, if both system use cesium resonance ionization image detector as a gated image detector, for the first system cesium resonance wavelength 852 and for the second one 894 nm can be used for road illuminating source of light.

Although multiple embodiment of the invention have been described in detail for purposes of illustration, various modifications may be made without departing from the spirit and scope of the invention. Accordingly, the invention is not to be limited except as by the appended claims.

Practical Features Benefits.

As we mentioned important practical feature of the invented road illumination system is its ability to provide higher quality of road visibility without blinding the drivers of oncoming vehicles. This will potentially diminish the probability of nighttime car crashes. Especially this is of great importance for elderly drivers. As described in a paper by A. J. McKnight, “Too old to drive”, Issues in Science and Technology, Winter 2000, p.1-10, elderly driver especially at the nighttime “are more likely to be injured or killed in an automobile accident than are driver in any other age group except for teenagers”.

Before this invention only two applications of global positioning system related to vehicles were known: to obtain the information about coordinates of vehicle and the information about closely moving vehicles to decrease the probability of collision crashes with them. By introducing two additional new applications (invisible illumination of the road and antitheft system) the multibillion dollars expenses for the GPS design, manufacturing and launching would become much better paid back.

There are many benefits which this invention provides:

1. Better visibility when driving at nighttime, more information about the road and its surroundings.

2. Probability to be blinded by the oncoming car will be at least two-three orders of magnitude less than for any other known system.

3. Simultaneously the vehicular system for invisible road illumination and imaging can be used not only for invisible road illumination but as an effective antitheft system

4. Since the preferred design for the first embodiment includes global positioning system consumers potentially may have four systems included into one compact device providing simultaneously: potent system for invisible road illumination, positioning system for vehicle, antitheft system, and collision avoidance, warning and control system (see for example patents:

#6275773 by J. H. Lemelson, and R. D. Pedersen, “GPS vehicle collision avoidance warning and control system and method” Aug. 14, 2001;

#6370475, by D. S. Breed, W. E. Duvall, W. C. Johnson, “Accident avoidance system”, Apr. 9, 2002.)

1. A device for vehicular invisible road illumination comprising:
(a) a gated spectrally selective image detector with luminosity-resolving power product at least 10⁴ cm² sr,
(b) at least one narrow band pulsed source of light which illuminates the road with a spectral bandwidth equal or less than the source of light wavelength divided by the spectral resolution of said gated image detector.

2. The image detector of claim 1 wherein the means for the image acquiring resonance ionization image detector is disposed.

3. The image detector of claim 1 wherein the means for the image acquiring resonance fluorescence imaging monochromator is disposed.

4. The image detector of claim 1 wherein the means for the image acquiring magnetooptical imaging filter is disposed.

5. The image detector of claim 1 wherein the means for image acquiring hole-burning spectroscopy filter is disposed.

6. A device for vehicular invisible road illumination comprising:
(a) a means for generating a triggering electromagnetic pulse, generated before the road illuminating pulse and directed in the same direction as the laser pulse from said illuminating pulsed laser,
(b) a means to detect separately and independently from said illuminating pulse said triggering electromagnetic pulse, connected through delay line with a predetermined the same for all vehicles delay time to a gate of said spectrally selective image detector.

7. A method for vehicular road illumination comprising:
(a) illumination of the road by light pulses which are shorter than the period of time equal to the illuminated and observed distance in front of the vehicle divided by the speed of light,
(b) period between illuminating pulses is set the same for all vehicles,
(c) said period between illuminating pulses is divided into a number of predetermined time intervals with predetermined duration of each interval,
(d) each said predetermined time interval is assigned for predetermined group of vehicles,
(e) precision of said period between road illuminating pulses is set equal to at least to ratio of duration of an idle interval, divided by time which is necessary for vehicle to travel said illuminated distance.

8. Timing signal to set precisely said in claim 7 said period between illuminating pulses is acquired from at least one global positioning system.

9. Said timing signal to set precisely said in claim 7 said period between illuminating pulses is acquired from the United States Global Positioning System.

10. Said timing signal to set precisely said in claim 7 said period between illuminating pulses is acquired from the Russian GLObal NAvigation Satellite System.

11. Said timing signal to set precisely said in claim 7 said period between illuminating pulses is acquired from the European Global Positioning System.
